(19) United States
(12) Patent Application Publication
(10) Pub. No.: US 2015/0334720 A1
(43) Pub. Date: Nov. 19, 2015

(54) Profile-Based Noise Reduction

(71) Applicant: Shaul Simhi, Tel-Mond (IL)

(72) Inventor: Shaul Simhi, Tel-Mond (IL)

(21) Appl. No.: 14/695,084

(22) Filed: Apr. 24, 2015

Related U.S. Application Data
(60) Provisional application No. 61/992,313, filed on May 13, 2014.

(51) Int. Cl. H04W 72/08; H04B 15/02

(52) U.S. Cl. CPC H04W 72/085; H04B 15/02

(57) ABSTRACT

This application relates to the way that a noise reduction filter can be applied for improving audio quality during calls. The personal approach that was introduced in the related application entails a significant barrier to wide spread deployment. This application introduces the profile-based approach which overcomes this barrier by enabling a transparent out-of-the-box usage and therefore enabling a wide spread deployment of this technology.

### RELATED APPLICATIONS

This application is a continuation work to U.S. Pat. No. 8,175,874 B2 granted on May 8, 2012 which is incorporated by reference in its entirety.

### FIELD OF THE INVENTION

The present invention relates generally to the way that a noise reduction filter can be applied for improving audio quality during calls. More specifically this invention introduces the profile-based noise reduction which significantly improves the usage and operation of the personal noise reduction method that was introduced in the related application.

### BACKGROUND OF THE INVENTION

As discussed in the related application, information that is known on the user that is speaking (the “speaker”) can be used to improve audio quality during calls. This information (the “registration”) can be used to identify the areas in which the speaker is talking (personal VAD—voice activity detection) and to utilize techniques like source separation to enhance the voice of the speaker while attenuating the background noise.

The usage of a personal noise reduction system is not transparent to the end user and requires some initial effort from the speaker, for example to record a voice sample. The personal noise reduction might also be sensitive to audio distortion that can be introduced by different audio filters (e.g. codecs) or capture devices (e.g. microphones). Therefore, in such cases, a good practice is that both the registration and the audio during the call will have the same distortion—for example, the calls and the registration will be made using similar microphones. This good practice makes the creation of a personal registration by the speaker to be a non-trivial task especially if the speaker is making calls using multiple environments—for example, using multiple microphones, using multiple communication devices etc. This initial effort of activating the personal noise reduction is a barrier for a widespread usage of this technology. To achieve a mass implementation of this technology, it should be capable of working out-of-the-box with minimal to zero initial effort.

In the last years, the technology of using multiple sensors, like a secondary reference microphone, in order to attenuate ambient noise became common for noise reduction especially in mobile phones. This technology has few inherent drawbacks especially when the phone is used in hands-free mode. Combining the multi-sensor approach with the registered profile approach can yield an improved noise reduction filter.

### SUMMARY OF THE INVENTION

An aspect of an embodiment of the invention relates to a system and method of transferring audio data in real-time wherein only the voice of a registered user will be transferred.

In an exemplary embodiment of the invention, the system uses pre-existing registration profiles to enable out-of-the-box activation. The system can be configured to work in a more tolerant mode in which the match of the voice during call with the registered information can be sparser. The registration profile does not have to belong to the speaker itself but can belong to a representative individual or group of people.

In some embodiments of the invention, the system can use registration profiles that were built using multiple audio capture devices and audio filters that aggregate different audio distortions.

In some embodiments of the invention, the system can be combined with reference streams of data to improve identification, attenuation of the ambient noise and quality of the output.

### BRIEF DESCRIPTION OF THE DRAWINGS

FIG. 1—System 100 access pre-prepared registration profiles (one or more) 101 and selects the best profile (one or more) 102. System 100 can also create a new registration profile (one or more) 103.

FIG. 2—System 100 contains an interface to a reference channel 201 for interacting with reference data.

### DETAILED DESCRIPTION

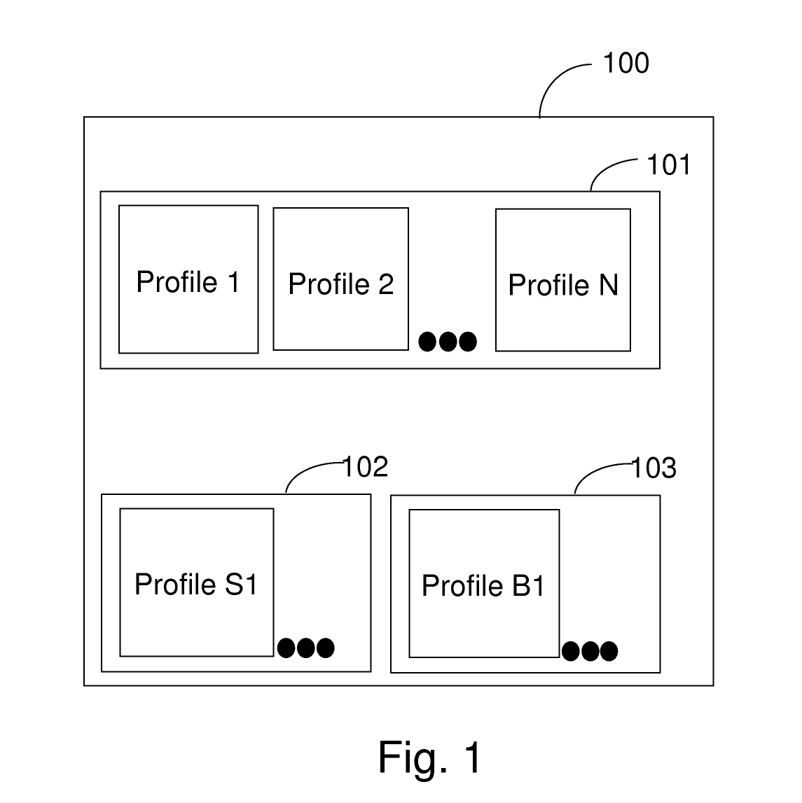

FIG. 1 illustrates that system 100 can access registration profiles 101 that were prepared in advance. System 100 can access the pre-existing registration profiles 101 in many ways. For example, the registration profiles 101 can be pre-loaded to system 100, or they can be downloaded from the network or can be access using an API.

The pre-existing registration profiles 101 may contain one or more profiles that were prepared in advanced for different representative profiles of speakers and environments like: English speaking male using the built-in microphone of the mobile phone, Chinese speaking female using both the built-in microphone and an external auxiliary microphone, female with soprano voice type, few English speaking people with bass voice type, few French people talking both in French and English, etc.

The pre-existing registration profiles 101 may contain recordings using different number of audio channels. For example, they may contain recordings with one channel (mono), recordings with two channels (stereo), recordings with more channels or any combination of the above.

If the pre-existing registration profiles 101 contain more than one profile, the speaker can select the profile (one or more) 102 that best matches his/her personal profile and usage environment. This selection can be done prior to a call or during the call. The selection can also be changed during the call if, for example, the speaker is changed during the call or the audio capture device is changed, etc.

System 100 may automatically select the best registration profile (one or more) 102 without the need for any explicit input from the speaker. This can be done, for example, by analyzing few audio segments during a call and finding the best match to the registration profiles 101, System 100 may look for match of different acoustic features like pitch, harmonics etc.

System 100 can also use non-audio data to select or improve the selection of the registration profile 102. For example: System 100 may analyze the interface language of the mobile device to decide on the language used by the speaker; System 100 may check the location of the device based on GPS data in order to guess the accent of the speaker; System 100 may analyze the personal profile of the speaker on a social network, like Facebook, to determine data like the age and gender of the speaker; System 100 may analyze the hardware device to identify the type of audio capture device that is being used.

The speaker can provide data to help system 100 with selecting the best registration profile(s) 102. For example, this data might be a self photo (i.e. photo of himself/herself), information on gender, age, language(s) that is/are spoken, accent of the speaker, information on the audio capture device etc. This data might also include audio recording, like video clip, of himself/herself. System 100 can use this information exclusively or combined with other audio data or non-audio data that was gathered during calls or prior to the calls.

System 100 can change the selected registration profile(s) 102 during calls or after the calls based on additional information that is gathers or any indication from the speaker.

System 100 can use the audio information and/or the non-audio information that is gathered during time in order to build a new profile (one or more) 103. The new profile 103 can be built from scratch or can be partially of fully based on one or more of the pre-existing profiles 101.

During calls or afterwards, System 100 can manipulate the set of the new registration profiles 103: create new profiles, change existing profiles or delete profiles.

System 100 can support multiple speakers that talk simultaneously or sequentially. For example, the selected registration profiles 102 and new profiles 103 can take into account the acoustic profile of all speakers.

System 100 can also remove audio artifacts that are not generated by ambient noise. For example, if the audio segments contain a residual echo, this residual echo can be attenuated by system 100 since, for example, its acoustic behavior is not similar to the registration profiles.

System 100 may provides the speakers with the option to adjust the level of aggressiveness for attenuating the ambient noise for all scenarios or for specific scenarios. Such scenarios might be, for example, once a new profile 103 is built and being used, when the speaker is talking from outside of the office, when the speaker is calling phone numbers that belong to his/her business colleagues, when the background noise contains music etc. Alternatively system 100 can automatically adjust the level of aggressiveness based on predefined rules.

System 100 can use the information that exists in the selected registration profiles 102 or new registration profiles 103 in order to enhance the voice quality during calls. For example, if the registration profiles were recorded in wide-band and the voice during call is recorded in narrow-band, system 100 can enhance the narrow-band recording by taking into account the missing wide-band frequencies. Another example, if the voice during the call suffers from a reduced quality due to compression that was applied on it, System 100 can use the high quality registration profiles to restore the quality that was lost during compression.

System 100 can be used to improve call quality in all directions of the audio. For example, if the near-end is talking to a far-end that is located in a noisy environment, System 100 can remove the incoming noise by selecting the best registration profile(s) 102 for the far-end speaker. More examples can be: System 100 can enhance the quality of the audio that is coming from the far-end by restoring frequencies that were damaged by the codec and network and/or realign frequencies that were misaligned by the codec.

System 100 can be executed in centralized locations to filter audio traffic in the network. For example it can be installed in the PBX or in the gateway.

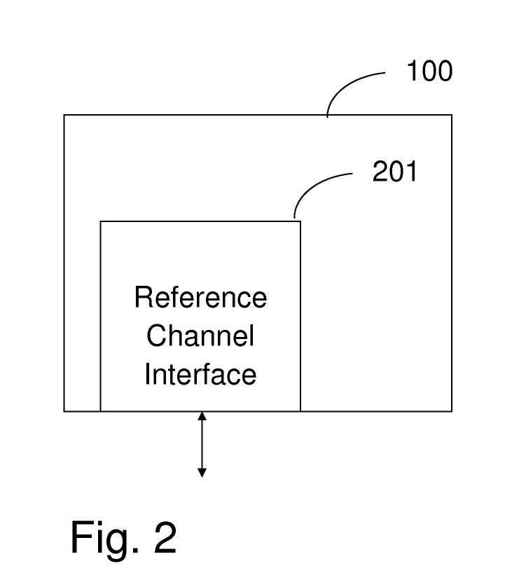

FIG. 2 illustrates how system 100 can have an interface to a reference channel 201 in order to access reference steam of data. The reference steam data may originate from a secondary microphone, multiple microphone array, jaw bone sensor, combination of the above, etc. There are many well known techniques for using reference stream of data to identify and attenuate ambient noise from the main stream of audio. When analyzing the audio in each segment, system 100 will take into account the reference stream of data combined with the registration profile in order to improve its VAD (Voice Activity Detection) decisions and to better separate the voice of the speaker from the ambient noise.

1: A method of transferring to a receiver in real time content of segments of an audio signal transmission of a call, the method comprising:
receiving registered profile containing profile characteristics;
receiving from a call an audio signal as a sequence of segments including segments that have user characteristics that were registered in the profile and other segments that do not have registered user characteristics;
analyzing at least one segment of the received audio signal to determine if it contains voice activity;
determining a probability level that the voice activity of the analyzed segment is of a registered user according to the registered profile; and
selectively transferring during the call the content of a segment to a receiver if the determined probability level is greater than a threshold value;
wherein the content of segments of the same call, for which the determined probability level is less than the threshold value, is suppressed completely or partially.

2: A method according to claim 1, further comprising filtering out noise from each segment before analyzing the segment.

3: A method according to claim 1, further comprising filtering out noise from each segment after analyzing the segment.

4: A method according to claim 1, further comprising performing source separation on the signal in a segment creating multiple segments before analyzing the segment and analyzing the multiple segments independently.

5: A method according to claim 1, further comprising multiple registered profiles.

6: A method according to claim 5, further comprising selecting registered profile(s) based on usage and/or user information.

7: A method according to claim 5, further comprising selecting registered profile(s) based on input from the user.

8: A method according to claim 1, further comprising enhancing the registered profile based on personal user characteristics.

9: A method according to claim 1, wherein said characteristics comprise voice patterns.

10: A method according to claim 1 further comprising allowing a user to select a suppression level by which unwanted sounds are attenuated.

11: A method according to claim 1 further comprising: receiving streams of segments from multiple sources.

12: A method according to claim 11 further comprising performing source separation on the signal in a segment based on the correlation between the multiple sources, creating multiple segments and analyzing the multiple segments independently.

13: A method according to claim 1 further comprising enhancing the quality of the speech.

14: A method according to claim 13 further comprising modifying frequencies that are missing, damaged or misaligned in the speech.

15: A method according to claim 1 further comprising attenuating audio artifacts.

16: A system for transferring to a receiver in real time content of segments of an audio transmission of a call, the system comprising:
a processor to process data of the real time audio transmission and to control the system;
a memory to serve as a work area for said processor;
a channel interface to provide an audio signal for processing and to transfer the processed audio signal to a receiver;
wherein said system is adapted to:
receiving registered profile containing profile characteristics;
receiving from a call an audio signal from the channel interface as a sequence of segments including segments that have user characteristics that were registered in the profile and other segments that do not have registered user characteristics;
analyzing with the processor at least one segment of the received audio signal to determine if it contains voice activity;
determining a probability level that the voice activity of the analyzed segment is of a registered user according to the registered profile;
and selectively transferring during the call the contents of a segment to the receiver if the determined probability level is greater than a threshold value;
wherein the contents of segments of the same call, for which the determined probability level is less than the threshold value, is suppressed completely or partially.

17: A system according to claim 16 further comprising a database memory to store data provided to the system for processing by said processor.

18: A system according to claim 16, wherein said processor performs source separation to the signal in a segment creating multiple segments before analyzing the segment and analyzing the multiple segments independently.

19: A processor for transferring to a receiver in real time content of segments of an audio signal transmission of a call, the processor comprising:
an audio signal interface; and
circuitry operative to:
receiving registered profile containing profile characteristics;
receive from a call through the audio signal interface an audio signal as a sequence of segments including segments that have user characteristics that were registered in the profile and other segments that do not have registered user characteristics;
analyze at least one segment of the received audio signal to determine if it contains voice activity;
determine a probability level that the voice activity of the analyzed segment is of a registered user according to the registered profile; and
selectively transfer through the audio signal interface during the call the content of a segment to a receiver if the determined probability level is greater than a threshold value;
wherein the content of segments of the same call, for which the determined probability level is less than the threshold value, is suppressed completely or partially.
